(19) United States
(12) Patent Application Publication
(10) Pub. No.: US 2026/0159186 A1
(43) Pub. Date: Jun. 11, 2026

(54) SYSTEM OF INSPECTING NOISE FOR VEHICLE AND METHOD THEREOF

(71) Applicants: HYUNDAI MOTOR COMPANY, Seoul (KR); Kia Corporation, Seoul (KR)

(72) Inventors: Myoung Gyo LEE, Hwaseong-si (KR); Kwanghyo PARK, Hwaseong-si (KR)

(21) Appl. No.: 19/239,278

(22) Filed: Jun. 16, 2025

(30) Foreign Application Priority Data
Dec. 9, 2024 (KR) 10-2024-0181571

(51) Int. Cl. B62D 65/00; G01M 17/007

(52) U.S. Cl. CPC B62D 65/005; G01M 17/007

(57) ABSTRACT

A system for inspecting a vehicle noise includes an inspection booth configured to accommodate a vehicle, a moving frame configured to move relative to the vehicle in the inspection booth, a middle blower disposed at the moving frame and configured to blow air toward an upper surface of the vehicle, a first side blower disposed at the moving frame and configured to blow air toward a first side of the vehicle, a second side blower disposed at the moving frame and configured to blow air toward a second side of the vehicle, a transport module that moves the moving frame along a predetermined direction, and a controller configured to control the middle blower, the first side blower, the second side blower, and the transport module, and to determine a position and a level of the vehicle noise based on noise data measured from a microphone at the vehicle.

### CROSS-REFERENCE TO RELATED APPLICATION

This application claims priority to and the benefit of Korean Patent Application No. 10-2024-0181571, filed with the Korean Intellectual Property Office, on Dec. 9, 2024, the entire contents of which are incorporated herein by reference.

### TECHNICAL FIELD

The present disclosure relates to a system of inspecting a noise of a vehicle and a method thereof, and more particularly, the present disclosure relates to a system of inspecting a noise of a vehicle and a method capable of inspecting an abnormal noise generated when driving on an actual road during the production process of the vehicle.

### BACKGROUND

Vehicles may be driven on a road by operating various mechanical devices and parts such as driving systems, which may produce engine noise, drivetrain vibration noise, and wind noise. A vehicle quietness may be a factor for a customer to consider when choosing a product.

Vehicle production lines may conduct a vehicle driving inspection to determine abnormal noises occurring while the vehicle is driven. The vehicle driving inspection may be a final inspection to check for noises caused by various reasons such as assembly defects or operation defects of various devices, as the vehicle is a product assembled with various parts and mechanical devices.

For example, in vehicle driving tests, workers may drive the vehicle on the actual road to roughly estimate whether an abnormal sound and/or noises occur and the positions where the abnormal sound and/or noises occur.

In some cases, the vehicle driving inspection may not accurately or quantitatively detect the abnormal sound and/or the noise generated while the vehicle is driving.

In some cases, because the length of the road on which the vehicle travels at a high speed may be limited, the time available to detect the abnormal sounds and/or noise of the vehicle may be also limited.

In some cases, since the vehicle driving inspection is done by the driving on the actual road, the detection ability of the abnormal sound and/or noise depending on the external environment may be ununiform. For example, environmental influences such as snow, rain, or wind may affect the vehicle driving inspection, which may deteriorate the detection ability of the abnormal noise.

In some cases, since the worker determines whether the abnormal sound and/or noise occurs, a human error may cause a misjudgment, which may increase vehicle manufacturing costs due to the large number of the workers being involved in the vehicle driving inspection.

### SUMMARY

The present application describes a system of inspecting a noise of a vehicle and a method thereof, which can determine whether the noise and/or abnormal sound occurs during a high-speed driving of the vehicle without driving the vehicle on the actual road.

According to one aspect of the subject matter described in this application, a system for inspecting a vehicle noise includes an inspection booth configured to accommodate a vehicle, a supporting frame that supports the inspection booth, a moving frame configured to move relative to the vehicle in the inspection booth, a middle blower disposed at the moving frame and configured to blow air toward an upper surface of the vehicle, a first side blower disposed at the moving frame and configured to blow air toward a first side of the vehicle, a second side blower disposed at the moving frame and configured to blow air toward a second side of the vehicle, a transport module configured to move moving frame in a predetermined direction along the supporting frame of the inspection booth, and a controller configured to control the middle blower, the first side blower, the second side blower, and the transport module, and determine a position and a level of the vehicle noise based on noise data measured from a microphone that is disposed at the vehicle.

Implementations according to this aspect can include one or more of the following features. For example, the middle blower can be configured to rotate in a predetermined angular range relative to a driving direction of the vehicle and configured to move along a height direction of the vehicle. In some implementations, the middle blower can include a middle blowing motor configured to generate a wind, a middle end duct that defines a middle nozzle, the middle nozzle being configured to blow the wind generated from the middle blower onto the upper surface of the vehicle, a middle connection duct that fluidly connects the middle blower to the middle end duct, a middle auxiliary duct that is fluidly connected to the middle connection duct, a middle transport device configured to move the middle end duct and the middle auxiliary duct along the height direction of the vehicle, and a middle rotation device configured to rotate the middle end duct by a predetermined angle about an axis extending in a width direction of the vehicle.

In some examples, the middle transport device can include a first middle motor disposed at the moving frame and configured to generate power, a middle frame that is disposed at the moving frame and supports the middle auxiliary duct, the middle frame being configured to move in the height direction, a middle guide boss having (i) a first side that is fixedly disposed at the middle frame and (ii) a second side that is configured to move relative to the middle frame, and a first middle power delivery device disposed between the first middle motor and the middle guide boss and configured to move the middle frame based on the power generated from the first middle motor.

In some examples, the first middle power delivery device can include a first middle driving pulley disposed at the first middle motor, a first middle vertically-moving pulley that is engaged with the middle guide boss, and a middle transporting belt that connects the first middle driving pulley to the first middle vertically-moving pulley. In some examples, the middle rotation device can include a second middle motor disposed at the middle frame and configured to generate power, a second middle driving pulley disposed at a driving shaft of the second middle motor, a second middle vertically-moving pulley that is disposed at a rotation shaft of the middle end duct, and a middle rotation belt that connects the second middle driving pulley to the second middle vertically-moving pulley.

In some implementations, the first side blower and the second side blower can be configured to rotate in a predetermined angular range with respect to the height direction of the vehicle and configured to move along a width direction of the vehicle. In some examples, the first side blower and the second side blower face each other in the width direction.

In some implementations, the first side blower can include a first side motor configured to generate a wind, a first side end duct that defines a first side nozzle configured to blow the wind generated from the first side blower to the first side of the vehicle, a first side auxiliary duct disposed at the moving frame and connected to an upper part of the first side end duct, a first side connection duct that fluidly connects the first side blower to the first side auxiliary duct, a first side transport device configured to move the first side end duct and the first side auxiliary duct along the width direction of the vehicle, and a first side rotation device configured to rotate the first side end duct by a predetermined angle about an axis extending in the height direction of the vehicle.

In some examples, the first side transport device can include a first side linear guide that is disposed at the moving frame and defines a first guide groove, and a first side auxiliary frame that supports the first side auxiliary duct and comprises a first guide boss inserted into the first guide groove. In some examples, the first side rotation device can include a first side auxiliary flange that is disposed at the first side auxiliary duct and defines a plurality of first auxiliary flange holes arranged in a circumferential direction of the first side auxiliary duct, a first side end flange that is disposed at the first side end duct and defines a plurality of first end flange holes arranged in the circumferential direction, and a fastening member that couples one of the plurality of first auxiliary flange holes to one of the plurality of first end flange holes.

In some implementations, the second side blower can include a second side motor configured to generate a wind, a second side end duct that defines a second side nozzle configured to blow the wind generated from the second side blower to the second side of the vehicle, a second side auxiliary duct disposed at the moving frame and connected to an upper part of the second side end duct, a second side connection duct that fluidly connects the second side blower to the second side auxiliary duct, a second side transport device configured to move the second side end duct and the second side auxiliary duct along the width direction of the vehicle, and a second side rotation device configured to rotate the second side end duct by a predetermined angle about an axis extending in the height direction of the vehicle.

In some implementations, the second side transport device can include a second side linear guide that is disposed at the moving frame and defines a second guide groove, and a second side auxiliary frame that supports the second side auxiliary duct and comprises a second guide boss inserted into the second guide groove. In some examples, the second side rotation device can include a second side auxiliary flange that is disposed at the second side auxiliary duct and defines a plurality of second auxiliary flange holes arranged in a circumferential direction of the second side auxiliary duct, a second side end flange that is disposed at the second side end duct and defines a plurality of second end flange holes arranged in the circumferential direction, and a fastening member that couples one of the plurality of second auxiliary flange holes to one of the plurality of second end flange holes.

In some implementations, the transport module can include a transport motor disposed at the moving frame and configured to generate power, a transport power delivery device disposed between the transport motor and the supporting frame, and a transport guide disposed at the moving frame and configured to guide the moving frame. In some examples, the transport power delivery device can include a transport shaft configured to be rotated by the power of the transport motor, a transport driving pulley coupled to an end of the transport shaft, and a transport vertically-moving pulley coupled to the transport driving pulley and configured to be rotated based on rotation of the transport driving pulley, the transport vertically-moving pulley being configured to move along the supporting frame, and a transporting belt that connects the transport driving pulley to the transport vertically-moving pulley.

According to another aspect, a method for inspecting a vehicle noise includes providing a vehicle to an inspection booth configured to accommodate the vehicle, moving a blowing portal disposed at the inspection booth by a transport module based on a position of the vehicle in the inspection booth, the blowing portal including a middle blower, a first side blower, and a second side blower, blowing an air toward the vehicle while moving the middle blower, the first side blower, and the second side blower to predetermined inspection positions by the transport module, measuring noise data through a microphone disposed at the vehicle, and determining a position and a level of the vehicle noise based on the noise data.

Implementations according to this aspect can include one or more of the following features. For example, the method can further include determining a vehicle type through a barcode attached to the vehicle, determining the position of the vehicle in the inspection booth through a position sensor, and adjusting positions of the middle blower, the first side blower, and the second side blower based on the position of the vehicle and the vehicle type.

In some examples, the method can further include setting blowing conditions of the middle blower, the first side blower, and the second side blower. For instance, the blowing conditions can include a wind speed, a wind volume, and a wind pressure.

In some implementations, by determining the abnormal noise that occurs when the vehicle is actually driven on a road during the vehicle production process, labor costs and manufacturing costs for the vehicle production process can be reduced.

In some implementations, by detecting the abnormal noise of the vehicle while excluding external factors, a defect rate in determining the abnormal noise can be reduced.

### BRIEF DESCRIPTION OF THE DRAWINGS

The drawings are provided for reference to explain an illustrative example implementation of the present disclosure, and the technical spirit of the present disclosure should not be interpreted to be limited to the accompanying drawings.

FIGS. 1 and 2 are perspective views illustrating an example configuration of a system of inspecting a noise of a vehicle.

FIG. 3 is a block diagram showing an example configuration of the system.

FIGS. 4 and 5 are perspective views showing example components of the system.

FIGS. 6A-8F are views illustrating examples of a middle blower, a first side blower, and a second side blower of the system.

FIG. 9 is a flowchart illustrating an example of a method for inspecting a vehicle noise.

FIG. 10 is a view illustrating an example of a computing device.

### DETAILED DESCRIPTION

In the present application, one or more of methods or aspects thereof below can be executed by at least one or more controllers. The term “controller” can refer to a hardware device that includes memory and a processor. The memory is configured to store program instructions, and the processor is specifically programmed to execute the program instructions to perform one or more processes, as described in more detail below. The controller can control the operation of units, modules, components, devices, or the like, as described herein. Additionally, it is understood that the methods below can be implemented by a device including the controller together with one or more other components, as would be appreciated by a person of ordinary skill in the art.

Additionally, the controller of the present disclosure can be implemented as a non-transitory computer-readable recording medium containing executable program instructions executed by a processor. Examples of computer-readable recording media include ROM, RAM, compact disk (CD) ROM, magnetic tapes, floppy disks, flash drives, smart cards, and optical data storage devices, but is not limited thereto. The computer-readable recording media can also be dispersed across a computer network so that program instructions can be stored and executed in a dispersed manner, for example, on a telematics server or a controller region network (Controller Area Network; CAN).

The present disclosure will be described more fully hereinafter with reference to the accompanying drawings, in which example implementations of the disclosure are shown. As those skilled in the art would realize, the described implementations can be modified in various different ways, all without departing from the spirit or scope of the present disclosure.

Descriptions of parts not related to the present disclosure are omitted, and like reference numerals designate like elements throughout the specification.

Further, since sizes and thicknesses of constituent members shown in the accompanying drawings are arbitrarily given for better understanding and ease of description, the present disclosure is not limited to the illustrated sizes and thicknesses, and the thickness is enlarged to clearly express various parts and regions.

A system of inspecting a noise of a vehicle is described in detail with reference to attached drawings.

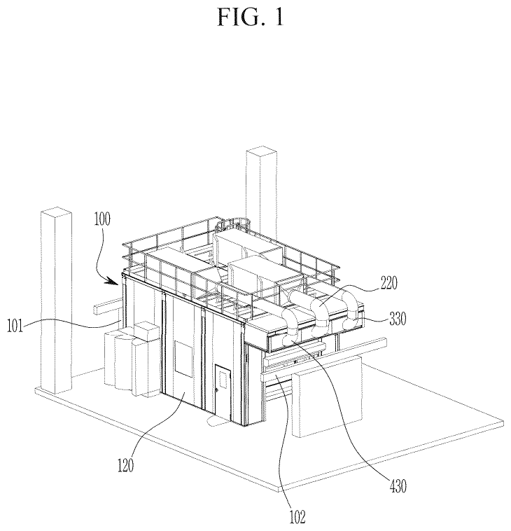

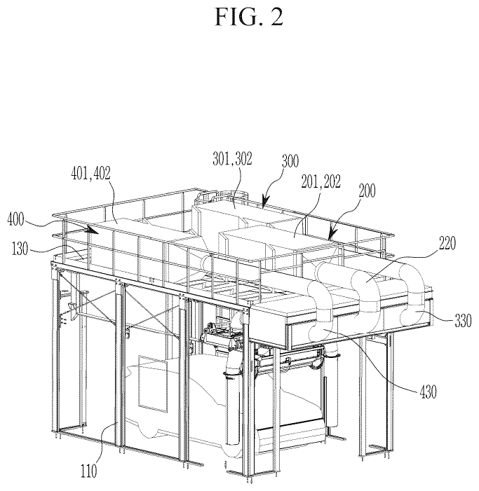

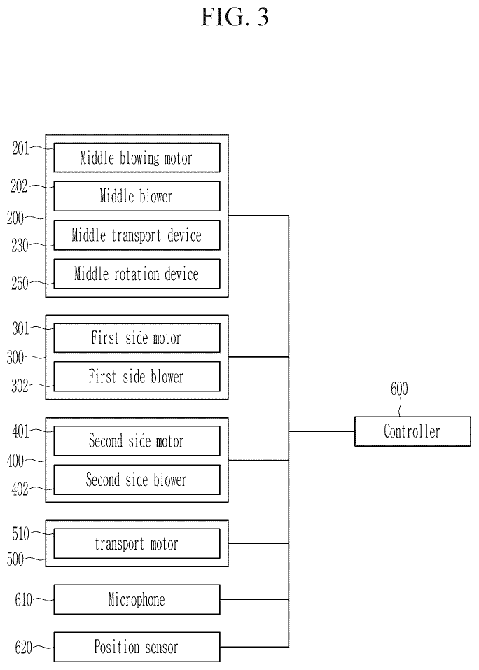

FIG. 1 and FIG. 2 are perspective views illustrating an example configuration of a system for inspecting a vehicle noise. FIG. 3 is a block diagram showing an example configuration of the system.

In some implementations, as shown in FIG. 3, the system can include an inspection booth 100, a middle blower assembly 200, a first side blower, a second side blower, and a transport module 500.

For example, the inspection booth 100 can include a plurality of supporting frames 110 where a vehicle is accommodated and forming an appearance, a blocking plate 120 arranged between the plurality of supporting frames 110, and a mounting frame 130 provided on the supporting frames 110. An entrance door 101 for a vehicle entry can be formed on one side of the inspection booth 100, and an exit door 102 for a vehicle exit can be formed on the other side of the inspection booth 100. The interior of the inspection booth 100 can block an external noise from entering. A position sensor 620, which detects the position of the vehicle, can be installed in the supporting frame 110. The position of the vehicle detected by the position sensor 620 can be transmitted to the controller 600 described later.

In some implementations, a blowing portal can refer to a structure in which the middle blower assembly 200, the first side blower assembly 300, and the second side blower assembly 400 are mounted, where the blowing portal can be provided on the moving frame 160 between the supporting frames 110 of the inspection booth 100.

The middle blower assembly 200 can blow an air on the upper surface of the vehicle housed in the inspection booth 100. The middle blower assembly 200 can blow the wind generated from the middle blower 202 onto the upper surface of the vehicle through the middle nozzle 215. The middle blower assembly 200 can be rotatable at a predetermined angle (e.g., 45 degrees) with reference to the driving direction of the vehicle, and be equipped to be movable along the height direction of the vehicle. The detailed configuration of the middle blower assembly 200 will be described later.

The first side blower assembly 300 can blow an air toward one side (e.g., a left surface) of the vehicle. The first side blower assembly 300 can blow the wind generated from the first side blower 302 to the left-hand side of the vehicle through the first side nozzle 315. The first side blower assembly 300 can be rotatable by a predetermined angular range (e.g., 45 degrees) with the height direction of the vehicle as a reference, and can be equipped to be movable along the width direction of the vehicle. The detailed configuration of the first side blower assembly 300 will be described later.

The second side blower assembly 400 can blow an air toward the other side (e.g., a right surface) of the vehicle. The second side blower assembly 400 can blow the wind generated from the second side blower 402 to the left surface of the vehicle through the second side nozzle 415. The second side blower assembly 400 can be rotatable by a predetermined angular range (e.g., 45 degrees) with the height direction of the vehicle as a reference, and can be equipped to be movable along the width direction of the vehicle. The detailed configuration of the second side blower assembly 400 will be described later. The first side blower assembly 300 and the second side blower assembly 400 can be placed facing each other.

The transport module 500 can move the blowing portal to a predetermined position along the driving direction of the vehicle by the control signal of the controller 600.

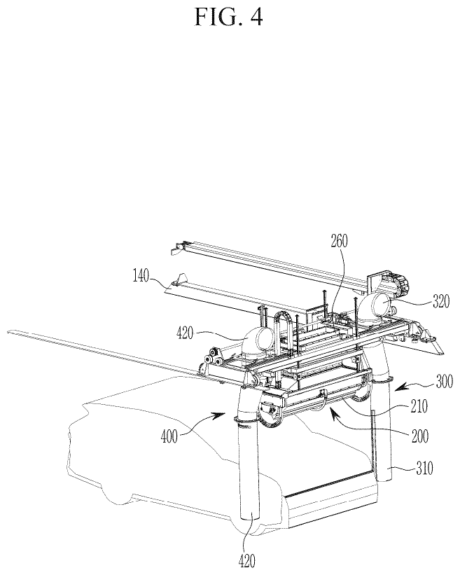

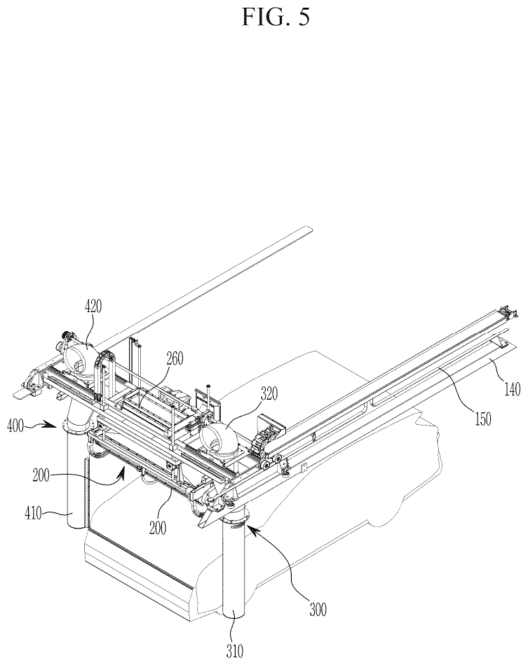

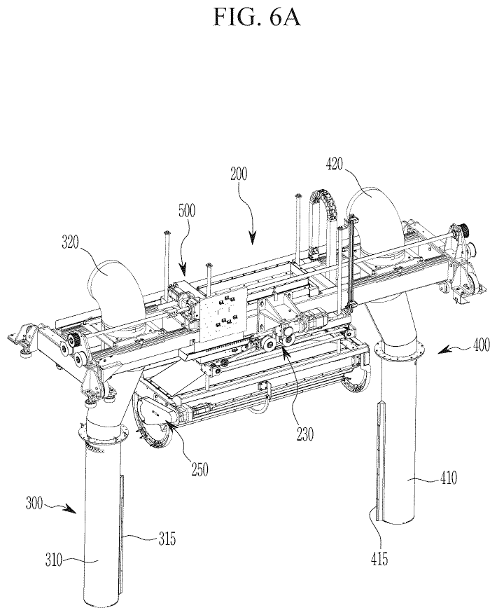

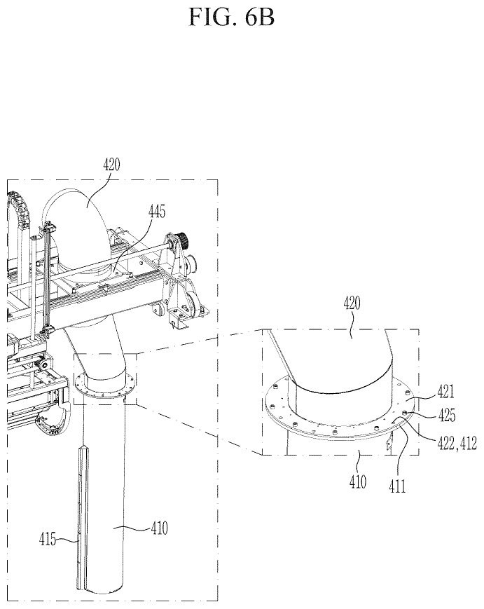

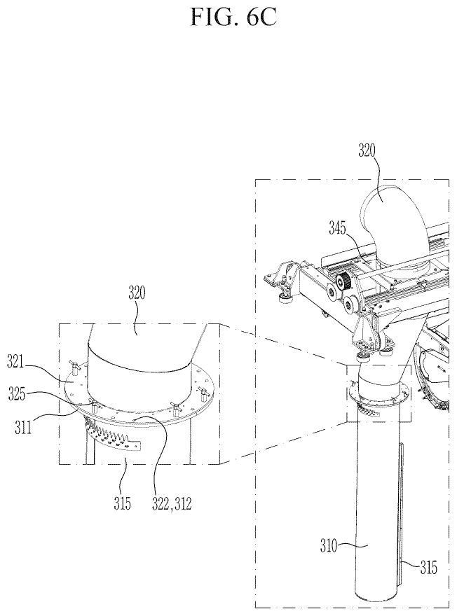

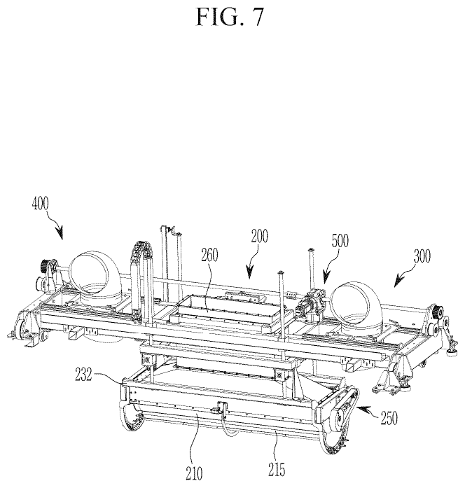

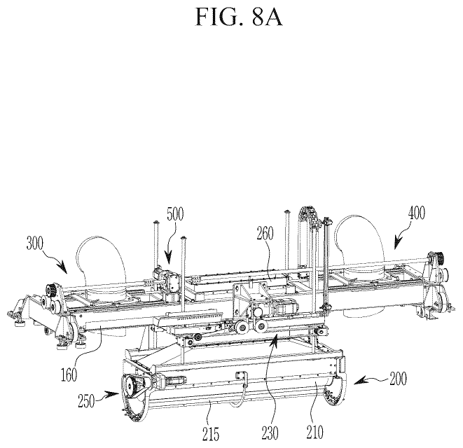

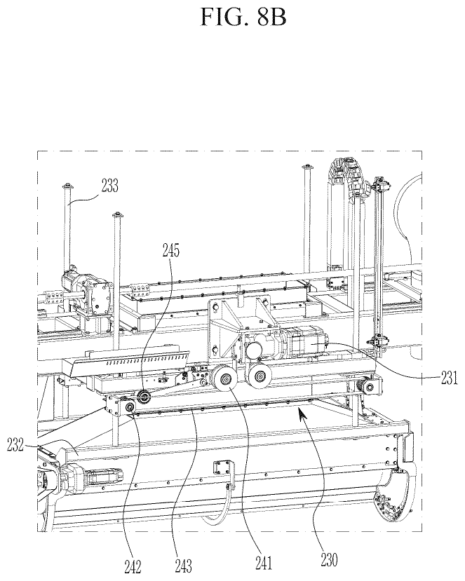

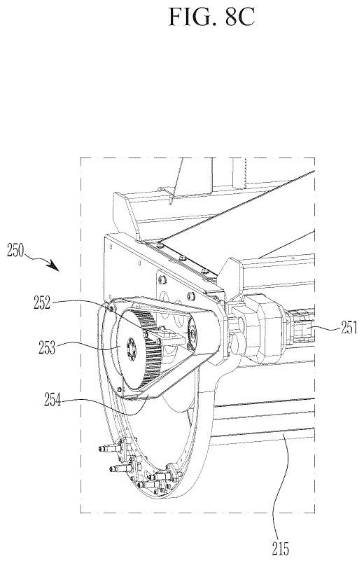

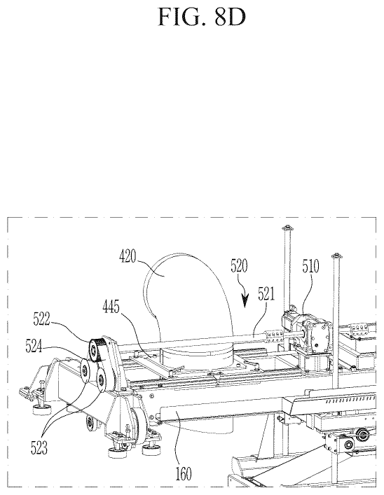

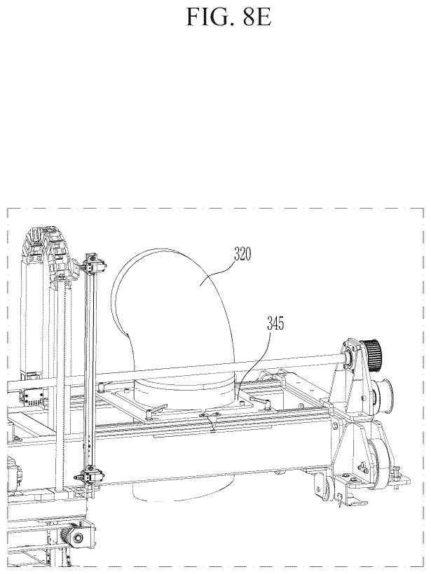

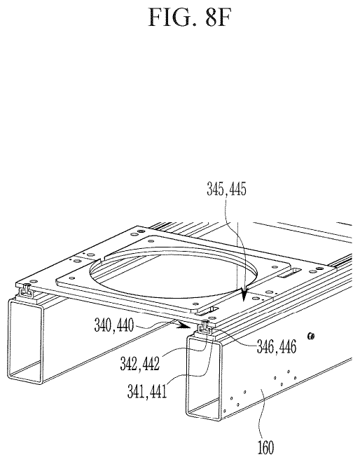

FIG. 4 and FIG. 5 are perspective views example components of the system. FIG. 6A to FIG. 8F are views for explaining a middle blower assembly 200, a first side blower assembly 300, and a second side blower assembly 400 of the system.

Referring to FIG. 4 to FIG. 8F, the middle blower assembly 200 can include a middle blower 202, a middle end duct 210, a middle auxiliary duct 260, a middle connection duct 220, a middle transport device 230, and a middle rotation device 250.

The middle blower 202 can generate a wind while being rotated by the power of the middle blowing motor 201. The middle blower 202 can be installed on the mounting frame 130 of the inspection booth 100.

The middle end duct 210 can blow the wind generated from the middle blower 202 onto the upper surface of the vehicle. For example, the middle end duct 210 can be placed on the upper part of the vehicle within the inspection booth 100, and the middle nozzle 215 can be formed in the middle end duct 210.

The middle auxiliary duct 260 can be connected to the upper part of the middle end duct 210, be movably provided on the moving frame 160, and be fixedly installed on the middle frame 232.

The middle connection duct 220 can be provided between the middle blower 202 and the middle auxiliary duct 260, and fluidly connect the middle blower 202 and the middle auxiliary duct 260. The middle connection duct 220 can transport the wind generated from the middle blower 202 to the middle end duct 210 through the middle auxiliary duct 260.

The middle transport device 230 can move the middle end duct 210 and the middle auxiliary duct 260 along the height direction of the vehicle.

In some examples, the middle transport device 230 can include a first middle motor 231, a middle frame 232, a middle guide boss 233, and a first middle power delivery device 240.

The first middle motor 231 can be equipped on the moving frame 160 and generate a power. The first middle motor 231 can be an electric motor, but the scope of the implementation is not limited thereto and can also be implemented via a hydraulic pressure motor, etc.

The middle auxiliary duct 260 can be mounted on the middle frame 232, and the middle frame 232 can be provided to be movable in the vertical direction with respect to the moving frame 160. The middle frame 232 can be installed on the plurality of supporting frames 110 so as to be movable along the driving direction of the vehicle.

The middle guide boss 233 can be installed fixedly on one side of the middle frame 232 and provided to be movable on the other side of the moving frame 160. The middle guide boss 233 can have a gear teeth formed along the vertical direction.

The first middle power delivery device 240 can be installed between the first middle motor 231 and the middle guide boss 233, and move the middle frame 232 in the vertical direction through the power generated from the first middle motor 231.

The first middle power delivery device 240 can include a first middle driving pulley 241 rotated by the first middle motor 231, a first middle vertically-moving pulley 242 gear-engaged with the middle guide boss 233, and a middle transporting belt 243 connecting the first middle driving pulley 241 and the first middle vertically-moving pulley 242. In some examples, a middle tension pulley 245 can be provided to apply a tension to the middle transporting belt 243. By applying the tension to the middle transporting belt 243 by the middle tension pulley 245, a power delivery between the first middle driving pulley 241 and the first middle vertically-moving pulley 242 can be made smooth.

When the first middle driving pulley 241 is rotated in one direction (e.g., a clockwise direction) by the first middle motor 231, the first middle vertically-moving pulley 242 connected through the middle transporting belt 243 rotates, and the middle guide boss 233 gear-engaged to the first middle vertically-moving pulley 242 moves in the upward direction. Accordingly, the middle frame 232 coupled to the lower end of the middle guide boss 233 moves upward, and the middle end duct 210 and the middle auxiliary duct 260 installed in the middle frame 232 move upward.

In some examples, if the first middle driving pulley 241 is rotated in the other direction (e.g., an anticlockwise) by the first middle motor 231, the first middle vertically-moving pulley 242 connected through the middle transporting belt 243 rotates, and the middle guide boss 233 gear-engaged to the first middle vertically-moving pulley 242 moves in the downward direction. Accordingly, the middle frame 232 coupled to the lower end of the middle guide boss 233 moves downward, and the middle end duct 210 and the middle auxiliary duct 260 installed in the middle frame 232 move downward.

The middle rotation device 250 can rotate the middle end duct 210 by a predetermined angle with reference to the vehicle width direction of the vehicle.

The middle rotation device 250 can include a second middle motor 251, a second middle driving pulley 252, a second middle vertically-moving pulley 253, and a middle rotation belt 254.

The second middle motor 251 can be installed on the side of the middle frame 232 and generate a power. The second middle motor 251 can be an electric motor, but the scope of the implementation is not limited thereto and can also be implemented via a hydraulic pressure motor, etc.

The second middle driving pulley 252 can be connected to the driving shaft of the second middle motor 251 and be rotated by the power of the second middle motor 251.

The second middle vertically-moving pulley 253 can be provided on the rotation shaft of the middle end duct 210 and be connected to the second middle driving pulley 252 via the middle rotation belt 254.

The middle rotation belt 254 can connect the second middle driving pulley 252 and the second middle vertically-moving pulley 253, and can transmit the power of the second middle motor 251 to the second middle vertically-moving pulley 253.

When the second middle driving pulley is rotated in one direction (e.g., the clockwise direction) by the second middle motor 251, the second middle vertically-moving pulley 253 connected through the middle rotation belt 254 rotates. Accordingly, as the second middle vertically-moving pulley 253 rotates, the middle end duct 210 rotates in one direction (e.g., the clockwise direction).

In some examples, when the second middle driving pulley 252 is rotated in the other direction (e.g., the anticlockwise) by the second middle motor 251, the second middle vertically-moving pulley 253 connected via the middle rotation belt 254 rotates. Accordingly, as the second middle vertically-moving pulley 253 rotates, the middle end duct 210 rotates in the other direction (e.g., the anticlockwise).

The first side blower assembly 300 can include a first side blower 302, a first side end duct 310, a first side auxiliary duct 320, a first side connection duct 330, a first side transport device 340, and a first side rotation device 350.

The first side blower 302 can generate a wind while being rotated by the power of the first side motor 301. The first side blower 302 can be installed on the mounting frame 130 of the inspection booth 100.

The first side end duct 310 can blow the wind generated from the first side blower 302 to one side (e.g., the left-hand side) of the vehicle. For example, the first side end duct 310 can be placed on the left-hand side of the vehicle, and a first side nozzle 315 can be formed in the first side end duct 310.

The first side auxiliary duct 320 can be connected to the upper part of the first side end duct 310 and can be movably installed on the moving frame 160.

The first side connection duct 330 can be provided between the first side blower 302 and the first side auxiliary duct 320, and fluidly connect the first side blower 302 and the first side auxiliary duct 320. The first side connection duct 330 can transport the wind generated from the first side blower 302 to the first side end duct 310 through the first side auxiliary duct 320.

In some examples, a portion of the first side connection duct 330 can be formed into a bellows shape. As the first side connection duct 330 is formed of the bellows shape, the change in the length that occurs when the first side auxiliary duct 320 and the first side end duct 310 move along the driving direction and the width of the vehicle, can be absorbed.

The first side transport device 340 can include a first side linear guide 341 and a first side auxiliary frame 345. The first side linear guide 341 can be provided on the moving frame 160, and a first guide groove 342 can be formed on the first side linear guide 341. The first side auxiliary frame 345 can support the outer side of the first side auxiliary duct 320, and a first guide boss 346 that is movably inserted into the first guide groove 342 can be formed.

Since the first guide boss 346 is inserted into the first guide groove 342, when the worker applies a force to the first side auxiliary duct 320 and/or the first side end duct 310 in one direction (e.g., the left direction), the first side auxiliary frame 345 can move to the left along the first side linear guide 341.

In some examples, since the first guide boss 346 is inserted into the first guide groove 342, when the worker applies a force in the other direction (e.g., the rightward direction) to the first side auxiliary duct 320 and/or the first side end duct 310, the first side auxiliary frame 345 can move to the right along the first side linear guide 341.

The first side rotation device 350 can include a first side auxiliary flange 321 formed in the first side auxiliary duct 320, and a first side end flange 311 formed in the first side end duct 310. A plurality of first side auxiliary flange 321 holes can be formed along the circumferential direction in the first side auxiliary flange 321, and a plurality of first side end flange 311 holes can be formed along the circumferential direction in the first side end flange 311. The first side auxiliary flange 321 holes and the first side end flange 311 holes can be formed at corresponding positions. The first side end flange 311 and the first side auxiliary flange 321 can be joined via a fastening member (e.g., a bolt, etc.). The worker can adjust the rotation angle of the first side end duct 310 by adjusting the positions of the first side auxiliary flange 321 hole and the first side end flange 311 hole.

In some implementations, the first side rotation device 350 can be implemented by having the first side auxiliary duct 320 rotatably supported on the first side auxiliary frame 345. In this case, the worker can also adjust the rotation angle of the first side end duct 310 by rotating the first side auxiliary duct 320.

The second side blower assembly 400 can include a second side blower 402, a second side end duct 410, a second side auxiliary duct 420, a second side connection duct 430, a second side transport device 440, and a second side rotation device 450.

The second side blower 402 can generate a wind while being rotating by the power of the second side motor 401. The second side blower 402 can be installed on the mounting frame 130 of the inspection booth 100.

The second side end duct 410 can blow the wind generated from the second side blower 402 to the other side (e.g., the right-hand side) of the vehicle. For example, the second side end duct 410 can be placed on the right-hand side of the vehicle, and a second side nozzle 415 can be formed in the second side end duct 410.

The second side auxiliary duct 420 can be connected to the upper part of the second side end duct 410 and be movably installed on the moving frame 160.

The second side connection duct 430 can be provided between the second side blower 402 and the second side auxiliary duct 420, and fluidly connect the second side blower 402 and the second side auxiliary duct 420. The second side connection duct 430 can transport the wind generated from the second side blower 402 to the second side end duct 410 through the second side auxiliary duct 420.

In some examples, a portion of the second side connection duct 430 can be formed into a bellows shape. As the second side connection duct 430 is formed into the bellows shape, the second side auxiliary duct 420 and the second side end duct 410 can absorb the change in the length that occurs when moving along the vehicle's driving direction and the vehicle width direction.

The second side transport device 440 can include a second side linear guide 441 and a second side auxiliary frame 445. The second side linear guide 441 can be provided on the moving frame 160, and a second guide groove 442 can be formed on the second side linear guide. The second side auxiliary frame 445 can support the outer side of the second side auxiliary duct 420, and a second guide boss 446 that is movably inserted into the second guide groove 442 can be formed.

Since the second guide boss 446 is inserted into the second guide groove 442, when the worker applies a force to the second side auxiliary duct 420 and/or the second side end duct 410 in one direction (e.g., the left direction), the second side auxiliary frame 445 can move to the left along the second side linear guide 441.

In some examples, since the second guide boss 446 is inserted into the second guide groove 442, when the worker applies a force in the other direction (e.g., the rightward direction) to the second side auxiliary duct 420 and/or the second side end duct 410, the second side auxiliary frame 445 can move to the right along the second side linear guide 441.

The second side rotation device 450 can include a second side auxiliary flange 421 formed in the second side auxiliary duct 420, and a second side end flange 411 formed in the second side end duct 410. A plurality of second side auxiliary flange 421 holes can be formed along the circumferential direction in the second side auxiliary flange 421, and a plurality of second side end flange 411 holes can be formed along the circumferential direction in the second side end flange 411. The second side auxiliary flange 421 hole and the second side end flange 411 hole can be formed in corresponding positions. The first side end flange 311 and the first side auxiliary flange 321 can be coupled via a fastening member (e.g., a bolt, etc.). The worker can adjust the rotation angle of the second side end duct 410 by adjusting the positions of the second side auxiliary flange 421 hole and the second side end flange 411 hole.

In some implementations, the second side rotation device 450 can be implemented by having the second side auxiliary duct 420 rotatably supported on the second side auxiliary frame 445. In this case, the worker can also adjust the rotation angle of the second side end duct 410 by rotating the second side auxiliary duct 420.

The transport module 500 can include a transport motor 510, a transport power delivery device 520, and a transport guide 530.

The transport motor 510 can be installed in the moving frame 160 and can generate power. The transport motor 510 can be an electric motor, but the scope of the implementation is not limited thereto and can also be implemented via a hydraulic pressure motor, etc.

The transport power delivery device 520 can be provided between the supporting frames 110 of the transport motor 510. The transport power delivery device 520 can move the blowing portal along the driving direction of the vehicle through the power of the transport motor 510.

The transport power delivery device 520 can include a transport shaft 521 that rotates by a power of the transport motor 510, a transport driving pulley 522 coupled to the end of the transport shaft 521, and a transport vertically-moving pulley 523 connected to the transport driving pulley 522 via the transporting belt 524.

The transport shaft 521 can be arranged along the width direction of the vehicle and be rotated by the transport motor 510.

Transport driving pulley 522 can be provided at both ends of transport shaft 521 and rotate integrally with the transport shaft 521. The transport vertically-moving pulley 523 can be connected to the transport driving pulley 522 through the transport belt 524, and can rotate in conjunction with the transport driving pulley 522. While the transport vertically-moving pulley 523 rotates along the guide belt 150 provided on the supporting frame 110, the moving frame 160 can move along the driving direction of the vehicle.

Transport guide 530 can be equipped on the moving frame 160 and guide the movement of the moving frame 160. The transport guide 530 can include guide rollers provided at both ends of the moving frame 160. The transport guide 530 can be provided to be movable along the guide frame 140 provided between the supporting frames 110.

The vehicle noise inspection device of the present disclosure can include a controller 600 that controls the operations of the middle blower assembly 200, the first side blower assembly 300, the second side blower assembly 400, and the transport module 500.

For example, the controller 600 can be implemented by one or more processors operating according to a predetermined program, and the memory of the controller 600 stores program instructions programmed to perform each step of the vehicle noise inspection method according to the present disclosure through one or more processors.

The controller 600 can determine the position where an abnormal noise from the vehicle, such as a wind noise, occurs based on noise data measured through the microphone 610 installed inside the vehicle. In some examples, the controller 600 can determine a position and a level of a vehicle noise based on the noise data. For example, the controller 600 can determine whether the abnormal noise occurs at each position by performing an FFT spectrum analysis and extracting feature points from the noise data measured through the microphone 610 according to the positions of the middle blower assembly 200, the first side blower assembly 300, and the second side blower assembly 400. That is, the level of the vehicle noise can include noise levels at various frequency bands. In some examples, the controller 600 can also apply an upper and lower limit management by an octave analysis and an AI score management by Anomaly Detection.

Hereinafter, the operation of the system of inspecting the noise of the vehicle is described in detail with reference to attached drawings.

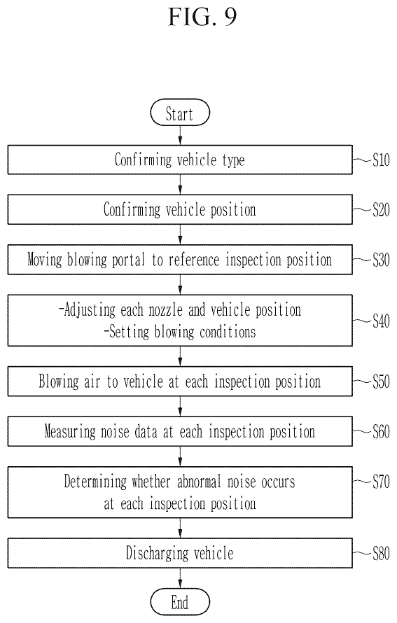

FIG. 9 is a flowchart illustrating an example of a method for inspecting a vehicle noise.

Referring to FIG. 9, when a vehicle enters an interior of an inspection booth 100 through an entrance door 101, a controller 600 can check the vehicle type of the vehicle. The controller 600 can check the vehicle type through a barcode attached to the vehicle (S10). Once the vehicle type of the vehicle is confirmed, the controller 600 can block the entrance door 101 of the inspection booth 100.

When the entrance door 101 of the inspection booth 100 is blocked, the controller 600 can check the position of the vehicle through position sensor 620 (S20).

Once the vehicle position is confirmed via the position sensor 620, the controller 600 can move the blowing portal to a reference inspection position of the vehicle via the transport module 500 S30.

When the blowing portal is moved to the reference inspection position, the controller 600 can control the position of the middle nozzle 215 and the vehicle through the middle transport device 230 and set the blowing conditions (e.g., a wind speed, a wind volume, and a wind pressure) of the middle blower assembly 200, the first side blower assembly 300, and the second side blower assembly 400 (S40).

The controller 600 sequentially moves the middle blower assembly 200 to a predetermined inspection position via the transport module 500, and at each inspection position, the middle blower assembly 200 can blow a wind at a predetermined wind speed on the upper surface of the vehicle. Simultaneously, at each inspection position, the first side blower assembly 300 and the second side blower assembly 400 can blow an air at a predetermined wind speed on both sides of the vehicle S50.

The inspection positions can include a plurality of upper inspection positions that apply an air to the upper surface of the vehicle via the middle blower assembly 200, and a plurality of side inspection positions that apply an air to both sides of the vehicle via the first side blower and the second side blower.

At this time, the upper inspection position can include a first upper inspection position to a fifth upper inspection position along the length direction of the vehicle. And the side inspection position can include a first side inspection position to a fifth side inspection position along the length direction of the vehicle.

At each inspection position, the microphone 610 measures the noise data, and the noise data measured through the microphone 610 can be transmitted to the controller 600. (S60). At this time, the controller 600 can measure the noise data inside the vehicle through the microphone 610 while controlling the wind speed, the wind volume, and the wind pressure blown from the middle blower assembly 200, the first side blower assembly 300, and the second side blower assembly 400. Through this, the abnormal noise such as the wind noise generated when the vehicle is driving on an actual road can be accurately measured. In addition, by measuring the noise data while adjusting the distance and the angle between the vehicle and the middle nozzle 215, the first side nozzle 315, and the second side nozzle 415, the detection ability of the noise data can be improved.

The controller 600 can analyze the noise data measured at each inspection position and determine whether the abnormal noise occurs at each inspection position. (S70).

Afterwards, the controller 600 can move the blowing portal to the home position via the transport module 500, and the vehicle can be discharged from the inspection booth 100 via the exit door 102 (S80).

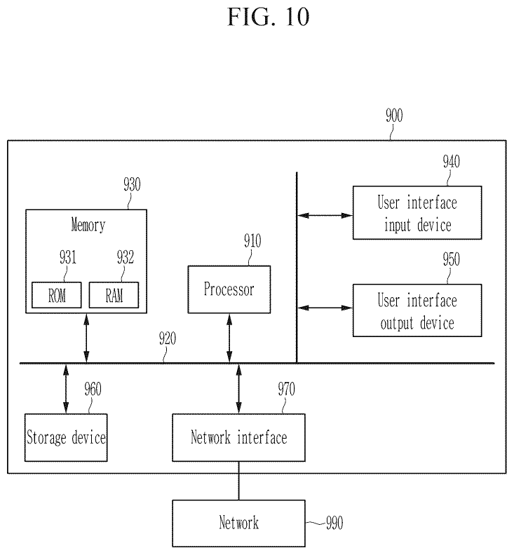

FIG. 10 is a drawing illustrating an example of a computing device.

Referring to FIG. 10, a noise measuring method of a vehicle can be implemented using a computing device 900.

The computing device 900 can include at least one of a processor 910, a memory 930, a user interface input device 940, a user interface output device 950, and a storage device 960 communicating via a bus 920. The computing device 900 can also include a network interface 970 electrically connected to the network 990. The network interface 970 can transmit or receive signals to other entities via the network 990.

The processor 910 can be implemented in various types such as a micro controller unit (MCU), an application processor (AP), a central processing unit (CPU), a graphic processing unit (GPU), a neural processing unit (NPU), etc., and can be any semiconductor device that executes instructions stored in the memory 930 or the storage device 960. The processor 910 can be configured to implement the functions and methods described above with reference to FIG. 1 to FIG. 9.

The memory 930 and the storage device 960 can include various forms of volatile or non-volatile storage media. For example, the memory can include a read-only memory (ROM) 931 and a random-access memory (RAM) 932. In the present implementation, the memory 930 can be positioned internally or externally to the processor 910, and the memory 930 can be connected to the processor 910.

In some implementations, at least some components or functions of the vehicle noise measurement apparatus and method according to implementations can be implemented as a program or software executing on a computing device 900, and the program or software can be stored on a computer-readable medium.

In some implementations, at least some components or functions of the vehicle noise measuring method according to implementations can be implemented using hardware or circuitry of the computing device 900, or can be implemented as separate hardware or circuitry that can be electrically connected to the computing device 900.

While this disclosure has been described in connection with what is presently considered to be practical example implementations, it is to be understood that the disclosure is not limited to the disclosed implementations, but, in some cases, is intended to cover various modifications and equivalent arrangements included within the spirit and scope of the appended claims.

What is claimed is:

1. A system for inspecting a vehicle noise, the system comprising:
an inspection booth configured to accommodate a vehicle;
a supporting frame that supports the inspection booth;
a moving frame configured to move relative to the vehicle in the inspection booth;
a middle blower disposed at the moving frame and configured to blow air toward an upper surface of the vehicle;
a first side blower disposed at the moving frame and configured to blow air toward a first side of the vehicle;
a second side blower disposed at the moving frame and configured to blow air toward a second side of the vehicle;
a transport module configured to move moving frame in a predetermined direction along the supporting frame of the inspection booth; and
a controller configured to:
control the middle blower, the first side blower, the second side blower, and the transport module, and
determine a position and a level of the vehicle noise based on noise data measured from a microphone that is disposed at the vehicle.

2. The system of claim 1, wherein the middle blower is configured to rotate in a predetermined angular range relative to a driving direction of the vehicle and configured to move along a height direction of the vehicle.

3. The system of claim 2, wherein the middle blower comprises:
a middle blowing motor configured to generate a wind;
a middle end duct that defines a middle nozzle, the middle nozzle being configured to blow the wind generated from the middle blower onto the upper surface of the vehicle;
a middle connection duct that fluidly connects the middle blower to the middle end duct;
a middle auxiliary duct that is fluidly connected to the middle connection duct;
a middle transport device configured to move the middle end duct and the middle auxiliary duct along the height direction of the vehicle; and
a middle rotation device configured to rotate the middle end duct by a predetermined angle about an axis extending in a width direction of the vehicle.

4. The system of claim 3, wherein the middle transport device comprises:
a first middle motor disposed at the moving frame and configured to generate power;
a middle frame that is disposed at the moving frame and supports the middle auxiliary duct, the middle frame being configured to move in the height direction;
a middle guide boss having (i) a first side that is fixedly disposed at the middle frame and (ii) a second side that is configured to move relative to the middle frame; and
a first middle power delivery device disposed between the first middle motor and the middle guide boss and configured to move the middle frame based on the power generated from the first middle motor.

5. The system of claim 4, wherein the first middle power delivery device comprises:
a first middle driving pulley disposed at the first middle motor;
a first middle vertically-moving pulley that is engaged with the middle guide boss; and
a middle transporting belt that connects the first middle driving pulley to the first middle vertically-moving pulley.

6. The system of claim 5, wherein the middle rotation device comprises:
a second middle motor disposed at the middle frame and configured to generate power;
a second middle driving pulley disposed at a driving shaft of the second middle motor;
a second middle vertically-moving pulley that is disposed at a rotation shaft of the middle end duct; and
a middle rotation belt that connects the second middle driving pulley to the second middle vertically-moving pulley.

7. The system of claim 2, wherein the first side blower and the second side blower are configured to rotate in a predetermined angular range with respect to the height direction of the vehicle and configured to move along a width direction of the vehicle.

8. The system of claim 7, wherein the first side blower and the second side blower face each other in the width direction.

9. The system of claim 7, wherein the first side blower comprises:
a first side motor configured to generate a wind;
a first side end duct that defines a first side nozzle configured to blow the wind generated from the first side blower to the first side of the vehicle;
a first side auxiliary duct disposed at the moving frame and connected to an upper part of the first side end duct;
a first side connection duct that fluidly connects the first side blower to the first side auxiliary duct;
a first side transport device configured to move the first side end duct and the first side auxiliary duct along the width direction of the vehicle; and
a first side rotation device configured to rotate the first side end duct by a predetermined angle about an axis extending in the height direction of the vehicle.

10. The system of claim 9, wherein the first side transport device comprises:
a first side linear guide that is disposed at the moving frame and defines a first guide groove; and
a first side auxiliary frame that supports the first side auxiliary duct and comprises a first guide boss inserted into the first guide groove.

11. The system of claim 10, wherein the first side rotation device comprises:
a first side auxiliary flange that is disposed at the first side auxiliary duct and defines a plurality of first auxiliary flange holes arranged in a circumferential direction of the first side auxiliary duct;
a first side end flange that is disposed at the first side end duct and defines a plurality of first end flange holes arranged in the circumferential direction; and
a fastening member that couples one of the plurality of first auxiliary flange holes to one of the plurality of first end flange holes.

12. The system of claim 11, wherein the second side blower comprises:
a second side motor configured to generate a wind;
a second side end duct that defines a second side nozzle configured to blow the wind generated from the second side blower to the second side of the vehicle;
a second side auxiliary duct disposed at the moving frame and connected to an upper part of the second side end duct;
a second side connection duct that fluidly connects the second side blower to the second side auxiliary duct;
a second side transport device configured to move the second side end duct and the second side auxiliary duct along the width direction of the vehicle; and
a second side rotation device configured to rotate the second side end duct by a predetermined angle about an axis extending in the height direction of the vehicle.

13. The system of claim 12, wherein the second side transport device comprises:
a second side linear guide that is disposed at the moving frame and defines a second guide groove; and
a second side auxiliary frame that supports the second side auxiliary duct and comprises a second guide boss inserted into the second guide groove.

14. The system of claim 12, wherein the second side rotation device comprises:
a second side auxiliary flange that is disposed at the second side auxiliary duct and defines a plurality of second auxiliary flange holes arranged in a circumferential direction of the second side auxiliary duct;
a second side end flange that is disposed at the second side end duct and defines a plurality of second end flange holes arranged in the circumferential direction; and
a fastening member that couples one of the plurality of second auxiliary flange holes to one of the plurality of second end flange holes.

15. The system of claim 1, wherein the transport module comprises:
a transport motor disposed at the moving frame and configured to generate power;
a transport power delivery device disposed between the transport motor and the supporting frame; and
a transport guide disposed at the moving frame and configured to guide the moving frame.

16. The system of claim 15, wherein the transport power delivery device comprises:
a transport shaft configured to be rotated by the power of the transport motor;
a transport driving pulley coupled to an end of the transport shaft; and
a transport vertically-moving pulley coupled to the transport driving pulley and configured to be rotated based on rotation of the transport driving pulley, the transport vertically-moving pulley being configured to move along the supporting frame; and
a transporting belt that connects the transport driving pulley to the transport vertically-moving pulley.

17. A method for inspecting a vehicle noise, the method comprising:
providing a vehicle to an inspection booth configured to accommodate the vehicle;
moving a blowing portal disposed at the inspection booth by a transport module based on a position of the vehicle in the inspection booth, the blowing portal including a middle blower, a first side blower, and a second side blower;
blowing an air toward the vehicle while moving the middle blower, the first side blower, and the second side blower to predetermined inspection positions by the transport module;
measuring noise data through a microphone disposed at the vehicle; and
determining a position and a level of the vehicle noise based on the noise data.

18. The method of claim 17, further comprising:
determining a vehicle type through a barcode attached to the vehicle;
determining the position of the vehicle in the inspection booth through a position sensor; and
adjusting positions of the middle blower, the first side blower, and the second side blower based on the position of the vehicle and the vehicle type.

19. The method of claim 17, further comprising:
setting blowing conditions of the middle blower, the first side blower, and the second side blower.

20. The method of claim 19, wherein the blowing conditions include a wind speed, a wind volume, and a wind pressure.
